(19) United States
(12) Patent Application Publication
(10) Pub. No.: US 2026/0126995 A1
(43) Pub. Date: May 7, 2026

(54) TOOL FOR ACCURATELY DETECTING THE USE OF THIRD-PARTY LIBRARIES IN APPLICATIONS

(71) Applicant: AppCensus, Inc., Albany, CA (US)

(72) Inventors: Álvaro FEAL, A Coruña (ES); Narseo VALLINA-RODRIGUEZ, Madrid (ES); Joel REARDON, Calgary (CA); Serge EGELMAN, Berkeley, CA (US); Robert RICHTER, Paris (FR); Nathaniel GOOD, Albany, CA (US)

(73) Assignee: AppCensus, Inc., Albany, CA (US)

(21) Appl. No.: 19/122,208

(22) PCT Filed: Oct. 17, 2023
(86) PCT No.: PCT/US2023/077101

§ 371 Date: Apr. 17, 2025

Related U.S. Application Data
(60) Provisional application No. 63/379,877, filed on Oct. 17, 2022.

(51) Int. Cl. G06F 8/75

(52) U.S. Cl. CPC G06F 8/75

(57) ABSTRACT

Disclosed herein is a method performed by one or more computing devices to detect a use of third-party software libraries in an application. The method includes performing static and dynamic analysis of the application to detect one or more signals, generating a tree data structure representing hierarchical component names associated with the one or more signals, wherein each node of the tree data structure represents a path/sub-path of a hierarchical component name, annotating each of one or more nodes of the tree data structure to indicate signals associated with the path/sub-path represented by the node, determining a confidence score for each of the one or more nodes based on the signals, identifying nodes of the tree data structure having a confidence score that meets a threshold confidence score, and reporting one or more of the paths or sub-paths represented by the identified nodes as being associated with third-party software libraries.

### CROSS-REFERENCE TO RELATED APPLICATIONS

This application claims the benefit of U.S. Provisional Application No. 63/379,877 filed Oct. 17, 2022, which is hereby incorporated by reference.

### TECHNICAL FIELD

Embodiments of the invention relate to the field of automated software detection, and more specifically, a tool to detect the use of third-party software libraries in applications.

### BACKGROUND

Third-party software libraries (also referred to as third-party libraries) such as software development kits (SDKs) are fundamental to the development of modern applications. Third-party libraries provide application developers with functionality for performing a variety of tasks. For example, third-party libraries may provide functionality related to cryptography, graphics, anti-fraud, cross-platform development, and/or application integration with online platforms. The use of third-party libraries is considered good software engineering practice because it facilitates code reuse. Also, by nature, popular third-party libraries are more extensively tested and thus are more reliable. Despite the convenience provided by third-party libraries, the use of third-party libraries in mobile applications can have negative security and/or privacy consequences. From a security perspective, application developers may not diligently update the third-party libraries included in their software, thereby exposing users of those applications to unpatched vulnerabilities. Also, from a privacy perspective, third-party libraries may collect personal or sensitive data for secondary purposes such as advertising or user tracking. In the case of the Android operating system, third-party libraries execute with the same user ID and privileges as the host application, so they automatically gain access to the same set of permissions that the user granted to the host application. In some cases, a third-party library provider may even require (or recommend) in its documentation that application developers should expand the set of permissions requested by applications to enable the features of the third-party library. This phenomenon may lead to over-privileging, where certain permissions are not necessary for core application functionality, but instead to facilitate secondary usage by a third-party SDK provider. These privacy issues are aggravated by the lack of mechanisms in mobile operating systems to discern whether permissions are being requested by the application for legitimate reasons to enable the functionality of the application or being requested by third-party libraries for secondary purposes.

The ability to accurately detect third-party libraries (e.g., software development kits [SDKs]) and to characterize their behavior is vital for analyzing the security and/or privacy risks of software and their supply chain. This is especially true in the case of mobile applications (also referred to as “apps”) due to the increasing presence of potentially-intrusive third-party libraries in mobile applications that are used for analytics and advertising purposes.

Existing third-party library detection tools (e.g., Exodus, LibRadar, and LibScout) suffer from coverage and accuracy limitations due to their reliance on (1) a database of pre-defined code fingerprints of third-party libraries, and (2) static analysis methods to inspect an application's code to determine whether the mobile application's code matches any of the pre-defined code fingerprints. Therefore, to be effective, current static analysis methods require keeping the database of code fingerprints updated, which can be challenging, especially since new third-party library versions are constantly being released or updated, and third-party libraries are merged due to company acquisitions/merger.

Moreover, a static analysis approach to detecting third-party libraries is becoming increasingly ineffective as mobile application developers rely on code obfuscation tools to obfuscate their code and protect their intellectual property. Also, a static analysis approach may produce false negatives (e.g., if a third-party library is dynamically loaded at runtime); and false positives (e.g., if legacy or dead code associated with an SDK is conspicuously present but never executes).

Some existing third-party library detection tools perform dynamic analysis to detect third-party libraries. For example, a dynamic analysis approach may analyze the traffic generated by a mobile application while the mobile application is being executed to detect third-party host names contacted by the mobile application as a proxy to infer the presence of third-party libraries in the mobile application. However, just because a mobile application contacts a third-party host name does not necessarily mean that the application includes a third-party library associated with that host name. For instance, some third-party libraries allow mobile application developers to integrate multiple ad networks and analytics services using the same library (e.g., mediation SDKs). Thus, relying on a dynamic analysis approach to detect third-party libraries may generate false positives. Also, a dynamic analysis approach is prone to generating false negatives (e.g., underreporting third-party libraries) due to its inability to exhaustively test all code paths of a mobile application.

### BRIEF DESCRIPTION OF THE DRAWINGS

The invention may best be understood by referring to the following description and accompanying drawings that are used to illustrate embodiments of the invention. In the drawings:

FIG. 1 is a diagram showing the components of a third-party library detection tool, according to some embodiments.

FIG. 2 is a diagram showing an example of an annotated tree data structure, according to some embodiments.

FIG. 3 is a flow diagram showing a method for detecting third-party libraries in an application, according to some embodiments.

FIG. 4 is a block diagram showing an electronic/computing device, according to some embodiments.

### DETAILED DESCRIPTION

In the following description, numerous specific details such as logic implementations, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

Bracketed text and blocks with dashed borders (e.g., large dashes, small dashes, dot-dash, and dots) are used herein to illustrate optional operations that add additional features to embodiments of the invention. However, such notation should not be taken to mean that these are the only options or optional operations, and/or that blocks with solid borders are not optional in certain embodiments of the invention.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

An electronic device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, solid state drives, read only memory (ROM), flash memory devices, phase change memory) and machine-readable transmission media (also called a carrier) (e.g., electrical, optical, radio, acoustical or other form of propagated signals-such as carrier waves, infrared signals). Thus, an electronic device (e.g., a computer) includes hardware and software, such as a set of one or more processors (e.g., wherein a processor is a microprocessor, controller, microcontroller, central processing unit, digital signal processor, application specific integrated circuit, field programmable gate array, other electronic circuitry, a combination of one or more of the preceding) coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set of one or more physical network interface(s) (NI(s)) to establish network connections (to transmit and/or receive code and/or data using propagating signals) with other electronic devices. For example, the set of physical Nis (or the set of physical NI(s) in combination with the set of processors executing code) may perform any formatting, coding, or translating to allow the electronic device to send and receive data whether over a wired and/or a wireless connection. In some embodiments, a physical NI may comprise radio circuitry capable of receiving data from other electronic devices over a wireless connection and/or sending data out to other devices via a wireless connection. This radio circuitry may include transmitter(s), receiver(s), and/or transceiver(s) suitable for radiofrequency communication. The radio circuitry may convert digital data into a radio signal having the appropriate parameters (e.g., frequency, timing, channel, bandwidth, etc.). The radio signal may then be transmitted via antennas to the appropriate recipient(s). In some embodiments, the set of physical NI(s) may comprise network interface controller(s) (NICs), also known as a network interface card, network adapter, or local area network (LAN) adapter. The NIC(s) may facilitate in connecting the electronic device to other electronic devices allowing them to communicate via wire through plugging in a cable to a physical port connected to a NIC. One or more parts of an embodiment of the invention may be implemented using different combinations of software, firmware, and/or hardware.

A network device (ND) is an electronic device that communicatively interconnects other electronic devices on the network (e.g., other network devices, end-user devices). Some network devices are “multiple services network devices” that provide support for multiple networking functions (e.g., routing, bridging, switching, Layer 2 aggregation, session border control, Quality of Service, and/or subscriber management), and/or provide support for multiple application services (e.g., data, voice, and video). Modern smartphone platforms such as Android® implement a permission-based model to regulate access to these sensitive resources and data by third-party applications. The Android® permissions system has evolved over the years from an ask-on-install approach to an ask-on-first-use approach. While this change impacts when permissions are granted and how users can use contextual information to reason about the appropriateness of a permission request, the backend enforcement mechanisms have remained largely unchanged.

As mentioned above, existing third-party library detection tools (e.g., Exodus, LibRadar, and LibScout) suffer from coverage and accuracy limitations due to their reliance on static analysis and pre-defined code fingerprints to identify third-party libraries. Also, as mentioned above, third-party library detection tools that use a dynamic analysis approach to detect third-party libraries are prone to generating false positives and/or false negatives.

Embodiments are disclosed herein that are able to address one or more of the shortcomings of existing third-party library detection tools. Embodiments exploit the complementary strengths of static and dynamic analysis to detect the use of third-party libraries in applications. Embodiments are able to detect the use of third-party libraries without having to rely on maintaining a database of pre-defined code fingerprints of third-party libraries. That is, embodiments are able to accurately detect the presence and actual use of third-party libraries in applications without having prior knowledge of the code of third-party libraries, which allows embodiments to provide more coverage (e.g., detecting previously-unseen third-party libraries) compared to existing third-party library detection tools. Embodiments are more robust against false positives and false negatives than existing solutions. Embodiments holistically consider the nature and confidence of both static analysis signals and dynamic analysis signals to more accurately determine whether third-party libraries are being used in applications compared to existing third-party library detection tools. Embodiments are resilient against code obfuscation. Embodiments extract and combine static analysis and dynamic analysis signals that are resilient against basic obfuscation techniques and coverage limitations inherent to dynamic analysis methods. Also, embodiments employ an iterative fingerprint-based approach to deobfuscate third-party libraries seen in prior analysis with minimal human effort. The iterative approach may be used to maintain a knowledge base of deobfuscated code and to create a labeled set of SDK fingerprints attributed to specific library vendors or providers. While various technological advantages of embodiments are mentioned above, it should be appreciated that embodiments can provide other advantages not mentioned above in view of the present disclosure.

An embodiment is a method performed by one or more computing devices to accurately detect the use of third-party libraries in an application. The method includes performing static analysis of the application and dynamic analysis of the application to detect one or more signals indicative of the use of third-party libraries in the application, generating a tree data structure representing hierarchical component names associated with the one or more signals, wherein each level of the tree data structure represents a level of a component name hierarchy (e.g., a Java class name hierarchy), wherein each node of the tree data structure represents a path or sub-path of a hierarchical component name, annotating each of one or more nodes of the tree data structure to indicate signals associated with the path or sub-path represented by the node, determining a confidence score for each of the one or more nodes based on the signals associated with the path or sub-path represented by the node, identifying nodes of the tree data structure having a confidence score that meets a threshold confidence score, and reporting one or more of the paths or sub-paths represented by the identified nodes as being associated with third-party software libraries. Embodiments are further described herein with reference to the accompanying figures.

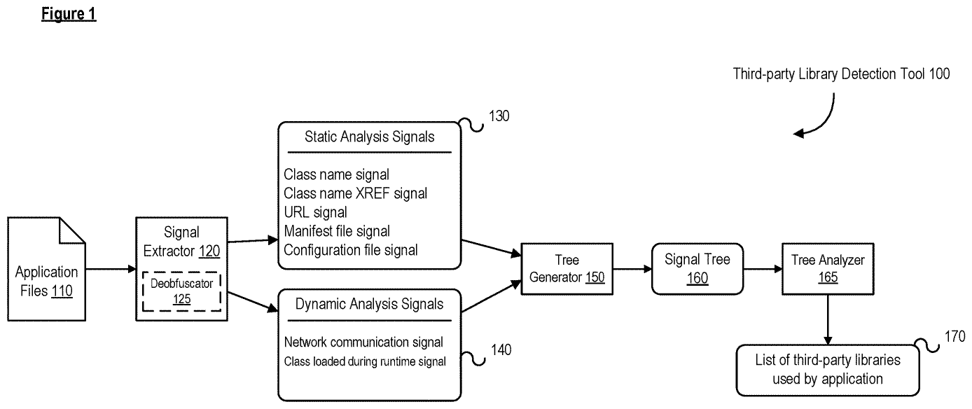

FIG. 1 is a diagram showing the components of a third-party library detection tool, according to some embodiments.

As shown in the diagram, the third-party library detection tool 100 includes a signal extractor 120, a tree generator 150, and a tree analyzer 165. As will be described in further detail herein below, the signal extractor 120 may provide signal extraction may perform signal extraction, the tree generator 150 may perform tree generation, and the tree analyzer 165 may perform tree analysis. The diagram shows a particular arrangement of components and a particular division of functionality among the components. It should be appreciated that this is provided by way of example to illustrate a particular embodiment and that other embodiments may use a different arrangement of components and/or a different division of functionality among components.

### Signal Extraction/Detection

The signal extractor 120 may extract signals from an application that are indicative of the use of third-party libraries in the application. The signal extractor 120 may receive the application files 110 of an application as input. The application files 110 may include various data associated with the application such as the application's code and the application's assets. In an embodiment, the application files 110 take the form of an Android Package Kit (APK) file or an iOS package App Store (IPA) file (e.g., which are used for distributing/installing applications on smartphones, tablets, and/or smart TVs). In an embodiment, the signal extractor 120 also receives other types of information regarding the application such as the application's metadata, the application's privacy policies, or any type of information that may be useful for extracting signals that are indicative of the use of third-party libraries. Embodiments are primarily described herein in a context where the application is a mobile application (or “app”). However, it should be appreciated that the techniques described herein can be applied to non-mobile applications (e.g., desktop applications and web applications) as well.

The signal extractor 120 may perform static analysis of the application to detect static analysis signals 130 associated with the application. Static analysis refers to a process of analyzing code without executing the code. Static analysis signals 130 may include a class name signal, a class name cross reference (XREF) signal, a uniform resource locator (URL) signal, a manifest file signal, and/or a configuration file signal, each of which is described in additional detail herein below. While certain static analysis signals are mentioned and described herein, it should be appreciated that these static analysis signals are provided by way of example and that embodiments are not limited thereto. It should be appreciated that other embodiments may use other types of static analysis signals.

### Class Name Signal

The signal extractor 120 may determine that the application includes a class name signal if the application's code includes a class (e.g., a Java class) with a class name that does not belong to the application's name space. The presence of a class in an application's code that does not belong to the application's name space suggests that the application may use a third-party library. However, relying solely on this signal may generate false positives due to the third-party library being unused (i.e., not executed) in the application (e.g., as part of legacy or unused code).

### Class Name XREF Signal

The signal extractor 120 may determine that the application includes a class name XREF signal if the application's main code invokes a class with a class name that does not belong to the application's name space. The signal extractor 120 may detect the class name XREF signal based on extracting the class names of all of the classes included in the application, disregarding any class names that share a name space with the application (since these are not likely to be associated with third-party libraries), and determining whether the application's main code references any of the classes with those class names.

### URL Signal

The signal extractor 120 may determine that the application includes a URL signal if the application's code includes a URL that is associated with a third-party library. Many third-party libraries interact with cloud-based services or upload data to a cloud/server (e.g., this is often the case with advertising and analytics services, or video game engines). Thus, the presence of a URL associated with a third-party library in the application's code may suggest that the application uses that third-party library. The signal extractor 120 may detect the URL signal based on extracting strings from application's code and then applying a regular expression to the strings to identify strings that are URLs.

### Manifest File Signal

The signal extractor 120 may determine that the application includes a manifest file signal if the application's manifest file (sometimes referred to as an “information property list”) includes elements that are associated with a third-party library. Many third-party libraries require application developers to include certain elements in the application's manifest file. The signal extractor 120 may detect the manifest file signal based on searching for certain elements that are associated with a third-party library in the application's manifest file such as custom permissions, services, providers, and/or receivers.

### Configuration File Signal

The signal extractor 120 may determine that the application includes a configuration file signal if the application includes assets/files that are associated with a third-party library. Many third-party libraries require having access to extra assets/files such as media files or string files for correct functioning. These assets/files are typically saved in specific folders that can be accessed when de-compiling the application. The presence of such assets/files may be particularly helpful for detecting the use of third-party libraries in applications that are heavily obfuscated.

The features/metadata associated with static analysis signals such as class names, URLs, manifest files, and configuration files may provide semantic information that is useful for detecting the use of third-party libraries in the application and/or to attribute the third-party libraries to the responsible organizations/parties. As mentioned above, the list of static analysis signals provided and described above is provided by way of example. Other embodiments may use other types of static analysis. For example, metadata such as the privacy labels of the application (e.g., which may be available on their store profile) and/or the privacy policy of the application may be used.

The signal extractor 120 may perform dynamic analysis of the application to detect dynamic analysis signals 140 associated with the application. Dynamic analysis refers to a process of analyzing code while the code is being executed. The dynamic analysis signals 140 may include a network communication signal and a class loaded during runtime signal, each of which is described in additional detail herein below. While certain dynamic analysis signals are mentioned and described herein, it should be appreciated that these dynamic analysis signals are provided by way of example and that embodiments are not limited thereto. It should be appreciated that other embodiments may use other types of dynamic analysis signals.

Dynamic analysis signals observed during runtime provide actual behavioral evidence of the use of third-party libraries in an application. For example, observing a transport layer security (TLS) connection to a host name associated with a party unrelated with the application developer (e.g., a hostname associated with a third-party analytics library/service) may suggest that the application is using a third-party library, even when the application is heavily obfuscated. The signal extractor 120 may perform dynamic analysis by instrumenting a device executing the application to monitor the device's access to the file system and/or to monitor the device's network traffic (e.g., using code instrumentation tools such as Frida).

### Network Communication Signal

The signal extractor 120 may determine that the application includes a network communication signal if the application communicates over a network with an entity that is associated with a third-party library. Network connections and metadata associated therewith (e.g., the host name or Internet Protocol (IP) address that the application is communicating with, the User-Agent (e.g., as identified in Hypertext Transfer Protocol (HTTP) requests), payload information, etc.) can contain useful information for detecting third-party libraries and the responsible organizations/parties. However, some third-party libraries such as libraries provided by ad-network aggregators may communicate with other third-party domains. For example, an ad-network aggregator may allow the application developer to choose from a list of ad networks to be aggregated through their library. Also, some third-party libraries related to development support (e.g., cryptography and/or user interface (UI) libraries) do not necessarily create network connections to their own services.

### Classes Loaded During Runtime Signal

The signal extractor 120 may determine that the application includes classes loaded during runtime if a class is loaded during runtime that does not belong to the application's name space. In an application executing on an Android mobile operation system, the signal extractor 120 may detect classes loaded during runtime based on instrumenting the Android runtime (ART) Java virtual machine to record whenever a class object is loaded during runtime. The detection of classes loaded during runtime signal may help increase the confidence levels of static analysis signals and help with detecting classes that could be missed by static analysis due to obfuscation. It is noted that it is possible for a class not to be loaded during a particular test because certain code paths are not reached during that test. However, this does not mean that such a class is never eventually loaded. This limitation can be overcome as the coverage of user interface (UI) fuzzing methods increases (i.e., they become more effective at exhaustively triggering code paths within a program).

The signal extractor 120 may thus extract various signals from the application, with different signals providing semantic information and different levels of confidence. The signal extractor 120 may determine a class name (or other type of hierarchical component name) associated with each signal. For some signals, determining the class name associated with those signals may be fairly straightforward. For example, the class name associated with the class name signal may be the class name of the class that was detected in the application code (and the class name can be extracted directly from the code). For some signals, the signal extractor 120 may need to perform extra processing to determine the class name associated with those signals. For example, the signal extractor 120 may determine the level of similarity between a string associated with the signal and a class name and associate the signal with the class name if the level of similarity meets a certain similarity threshold. For example, the URL “firebase.com” may be associated with the class name “com/firebase” but not “com/firebird”. In an embodiment, the gestalt pattern matching algorithm is used to determine string similarity (thus ignoring junk characters such as white spaces or blank lines). The gestalt pattern matching algorithm outputs a similarity score ranging from 0 (completely different) to 1 (exactly the same). In an embodiment, the threshold similarity score is set to 0.5 (as this has been found to provide a good balance between false positives and false negatives), but the threshold similarity score can be further configured.

Embodiments are primarily described herein in a context where class name (e.g., Java class name) is used to label/identify the library associated with a signal. However, it should be appreciated that this is by way of example only and that embodiments are not limited thereto. Other embodiments may use another type of hierarchical naming scheme to label/identify libraries. For example, embodiments may use a hierarchical component name other than class name that is inspired by the naming scheme of Java class names and package names. As another example, embodiments may use a hierarchical component name that is inspired by the naming scheme of domain name system (DNS) host names.

### Tree Generation

Once the signal extractor 120 extracts signals from the application, it may provide the signals to the tree generator 150. The tree generator 150 may generate a tree data structure representing class names associated with the signals (e.g., both static analysis signals and dynamic analysis signals) detected in the application. Each level of the tree data structure may represent a level of a class name hierarchy (or a level of another type of component name hierarchy), where each node of the tree data structure represents a path or sub-path of a class name.

In the case of Android and iOS, the hierarchical structure maps naturally to Java's package names and reverse hostname structures. For example, the class name “com.domain1.platform” may be represented in the tree data structure as three nodes connected to each other: “com->domain1->platform.” Similarly, a hostname extracted either statically or dynamically, maps to this hierarchical structure following their reverse order (e.g., “tracker.com” may be represented as “com->tracker”). If two class names share a common sub-path (e.g., “com/domain1” and “com/domain2”) they will share a common node (“com”) in the tree data structure. The use of a tree data structure allows for keeping a representation of the class names and hostnames associated with the signals detected in the application and their relationships. This approach also allows for detecting sub-products without any prior knowledge about them. For example, two class names sharing a common sub-path may share a common parent node in the tree data structure, which represents that the libraries associated with those class names may be sub-products of the same parent company (e.g., “com.domain1.ads” and “com.domain1.login” are sub-products of the “domain1” company).

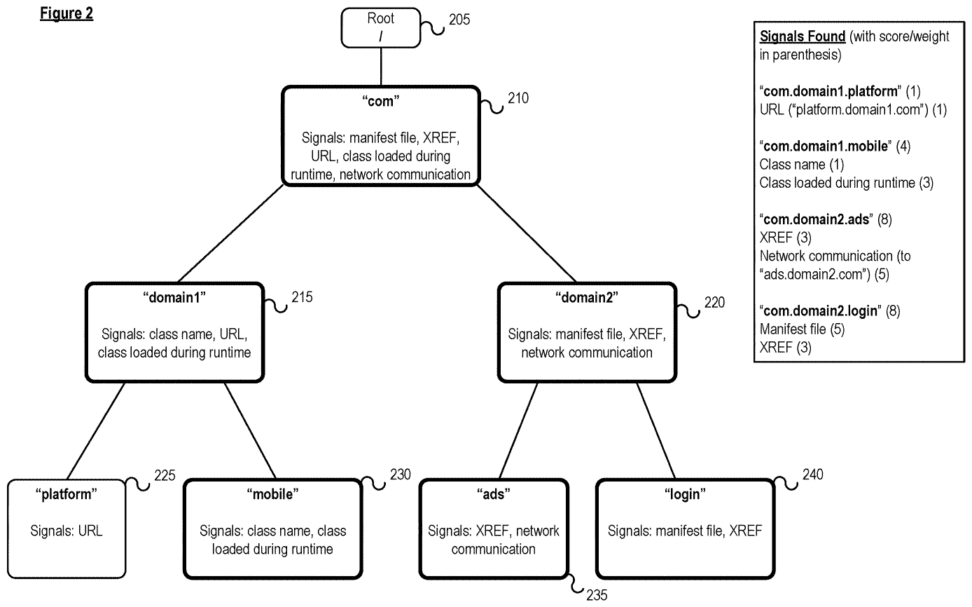

For each signal detected in the application, the tree generator 150 may traverse the tree data structure starting from the root node to look for a node that corresponds to the class name associated with the signal. If such a node does not already exist in the tree data structure, the tree generator 150 may add a new node representing the class name to the tree data structure and annotate the node (and any parent nodes) to indicate that the signal is associated with the class name. Otherwise, if a node that corresponds to the class name associated with the signal already exists in the tree data structure, the tree generator 150 may annotate the node (and any parent nodes) to indicate that the signal is associated with the class name. Thus, nodes in the tree data structure may be annotated to indicate the signals associated with the path or sub-path represented by those nodes. The tree generator 150 may provide the tree data structure (shown in the diagram as “signal tree” 160) to the tree analyzer. An example tree data structure is shown in FIG. 2 and further described herein below in relation thereto.

### Tree Analysis

The tree analyzer 165 may analyze the signal tree 160 to determine the paths or sub-paths that are associated with third-party libraries. The tree analyzer 165 may do this by determining a confidence score for nodes in the signal tree 160 based on the signals associated with the path or sub-path represented by the nodes (as indicated by the annotations added to the nodes). Different signals may provide different levels of confidence with regard to third-party libraries being used in the application. In an embodiment, each signal is assigned a weight that represents the confidence level provided by the signal and the tree analyzer 165 determines a confidence score for a node of the signal tree 160 based on summing weights of the signals associated with the path or sub-path represented by the node. In an embodiment, the weight assigned to a signal considers two aspects: (1) signal strength, which indicates how likely it is that a third-party library is being used in an application if the signal is detected; and (2) signal availability, which is a reflection of how often the signal is likely to appear in a given application.

Assigning weights to the different types of signals enables more flexible and accurate third-party library detection without relying on pre-compiled library fingerprints. If weights are assigned solely based on signal strength, the third-party library detection tool 100 may generate false negatives because some of the strongest signals associated with a given library may not be included in all applications where it is embedded (e.g., a service or custom permission related to a given third-party library or configuration flags that are specific to a third-party library). The weight values may be configurable to find a good compromise between false positives and false negatives.

In general, static analysis signals are considered weaker compared to dynamic analysis signals (static analysis signals are less indicative of the use of third-party libraries compared to dynamic analysis signals). As an example, a class name signal, a URL signal, and a configuration file signal may be considered relatively weak signals, but the confidence levels may increase when these signals are detected along with a class name XREF signal, a network communication signal, and/or a class loaded during runtime signal. In an embodiment, stronger signals that are more commonly present in applications are assigned relatively higher weight values (e.g., w=3, where w is the weight). In an embodiment, weaker signals (e.g., signals that are prone to generating false positives) and/or signals that are rarely present in applications (e.g., they can lead to under reporting) are assigned relatively lower weight values (e.g., w=1). In an embodiment, the class name XREF signal, the dynamic network communication signal, and/or the class loaded during runtime signal are assigned higher weights than the class name signal, the URL signal, and the manifest file signal (e.g., because the latter signals may represent legacy/dead code that does not get executed). In an embodiment, the signal annotations added to the signal tree 160 also include the weights assigned to the corresponding signals.

In an embodiment, the tree analyzer 165 determines a confidence score for a node of the signal tree 160 according to the following formula:

$${C}_{node} = \frac{{\sum }_{i = 1}^{n} {w}_{i}}{{total}_{weight}}$$

In the above formula, Cnode is the confidence score for the node, n is the number of signals associated with the path/sub-path represented by the node, wi is the weight assigned to the i-th signal, and total_{weight} is the sum of the weights of all possible signals that can be detected.

In an embodiment, the tree analyzer 165 determines a confidence score for a node based on determining separate confidence scores for static analysis signals (Cnode,s) and dynamic analysis signals (Cnode,d) and combining these two confidence scores into a single confidence score. For example, the confidence score for a node may be determined using the following formula:

$$Cnode = Cnode , s + Cnode , d$$

In this case, assuming that Cnode,s and Cnode, d each have a minimum value of 0 (e.g., no signals detected) and a maximum value of 1 (e.g., all signals detected), Cnode may have a minimum value of 0 and a maximum value of 2 (e.g., all static analysis signals and dynamic analysis signals are detected). This approach takes into account, for example, that many third-party libraries (e.g., development support libraries) do not establish network communications so it is common not to detect a network communication signal in such third-party libraries. The sum of the two confidence scores is taken instead of the product (multiplication) since taking the product may result in the final confidence score being zero if either the static analysis confidence score (Cnode,s) or the dynamic analysis confidence score (Cnode,d) is zero (which may result in a high false negative rate).

In an embodiment, the tree analyzer 165 identifies the nodes in the signal tree 160 that have a confidence score that is above a threshold confidence score and determines that the paths/sub-paths represented by the identified nodes as being associated with third-party libraries. The tree analyzer 165 may then generate a list 170 of third-party libraries used by the application based on the determined paths/sub-paths. For example, the paths/sub-paths may be mapped (either automatically by the third-party library detection tool 100 using approaches such as an iteratively compiled knowledge base or using information available on the web, or manually by a human user/analyst) to third-party libraries (e.g., the sub-path “com.firebase” may be mapped to the Google Firebase SDK).

In an embodiment, the threshold confidence score is set to 0.5 (so a path/sub-path represented by a node is determined as being associated with a third-party library if Cnode>=0.5 for that node). The threshold confidence score can have a different value depending on the implementation and may be configurable. In general, the threshold confidence score should be set to find a good balance between false positives and false negatives.

Since embodiments follow a hierarchical approach (the signal tree 160 is organized in a hierarchical manner), whenever the confidence score for a node is below the threshold confidence score, it may not be necessary to continue exploring its child branches, as the confidence score for the child nodes will also be below the threshold confidence score. Organizing evidence in a hierarchical tree data structure provides useful properties/features such as the ability to differentiate between different sub-products of the same library or organization. For example, if the tree data structure has nodes representing “com.domain.login” and “com.domain.ads,” but only the “login” node has a confidence score that meets the threshold confidence score, the tree analyzer 165 may be able to detect the use of a specific sub-product of the library.

Dealing with Obfuscation

Combining static analysis and dynamic analysis signals as described above makes the third-party library detection tool 100 resilient against code obfuscation in at least two ways. First, basic obfuscation methods (e.g., Proguard) lack the ability to modify the application's manifest file, asset files, and the runtime behavior of the application. Second, when application developers rely on more robust obfuscation techniques to obfuscate their code, dynamic analysis extracts application behaviors that can help detect potential third-party libraries and provide attribution information.

In an embodiment, to deal with more advanced obfuscation techniques, the third-party library detection tool 100 provides a semi-automatic analysis layer that leverages flexible knowledge to detect obfuscated third-party libraries. Embodiments are able to detect obfuscated third-party libraries having package names that are renamed to unintelligible strings that are different from the application's package name such as “a/b/c” or “zz/xyz”. Embodiments exploit the fact that a given third-party library might be obfuscated in some applications but not obfuscated in other applications. In an embodiment, the signal extractor 120 includes a deobfuscator 125. The deobfuscator 125 may maintain a knowledge base of fingerprints of non-obfuscated code included in third-party libraries and the non-obfuscated code. The deobfuscator 125 may generate the fingerprints based on code features that are not expected to change with obfuscation. For example, a fingerprint may be generated based on per-class collection of method signatures (e.g., return types and arguments types and juxtaposition) as well as unique strings that appear within the code. Since the types of arguments may themselves be obfuscated, the deobfuscator 125 may abstract out anything that is not part of the standard Java or Android APIs as a generic “object”. With this approach, whenever the deobfuscator 125 encounters obfuscated code, the deobfuscator 125 may generate a fingerprint of the obfuscated code and determine whether the fingerprint of the obfuscated code matches a fingerprint previously found on a non-obfuscated app in its knowledge base. The matching may be performed at a per-file or per-class level. So when comparing third-party libraries, for every file in the obfuscated library, if there is a file in the non-obfuscated library that closely matches in terms of the number of functions and the types they take and return (e.g., the function signature), and the string constants appearing in the codes are similar, then a match is reported. If the deobfuscator 125 determines that the fingerprint of the obfuscated code matches a fingerprint in its knowledge base, then the deobfuscator 125 may deobfuscate the obfuscated code using the non-obfuscated code associated with the fingerprint.

It is noted that the deobfuscation feature requires prior knowledge of third-party library code (but it is optional-third-party libraries can still be detected without the deobfuscation feature). In an embodiment, the knowledge base is updated as third-party libraries are encountered and detected. For example, if the third-party library detection tool 100 detects obfuscated code in application code but there is no matching fingerprint for the obfuscated code in the knowledge base, then the third-party library detection tool 100 may extract the obfuscated code and provide the obfuscated code to an analyst to be further analyzed. If the analyst is able to deobfuscate the obfuscated code, then the fingerprint for the obfuscated code may be added to the knowledge base with the deobfuscated code. If the third-party library detection tool 100 detects non-obfuscated code in an application that is determined to belong to a third-party library, the third-party library detection tool 100 may generate a new fingerprint for the code and add the fingerprint and the (non-obfuscated) code to the knowledge base. In this way, embodiments allow for the knowledge base of fingerprints to automatically (or semi-automatically) grow over time, which expands the third-party library detection tool's 100 ability to deal with obfuscation.

As described above, the third-party library detection tool 100 leverages the complementary strengths of static analysis and dynamic analysis to detect the use of third-party libraries in an application. The third-party library detection tool 100 takes into consideration the confidence levels provided by the different signals when detecting the use of third-party libraries. The third-party library detection tool 100 may thus be able to more accurately detect the use of third-party libraries in an application compared to approaches that rely solely on static analysis or dynamic analysis, even without having to maintain up-to-date code fingerprints.

The third-party library detection tool 100 may achieve better accuracy and reliability against unused code and false signals, and may be more resilient against advanced code obfuscation techniques. The third-party library detection tool 100 may be used for performing privacy and/or security analysis of applications. Also, application developers may use the third-party library detection tool 100 to identify third-party libraries in their applications so that they can remove any unnecessary third-party libraries and reduce the amount of code and/or permission requirements for their applications, which can improve application performance and/or make the applications less intrusive.

The third-party library detection tool 100 may provide practical applications for several use cases. For example, the third-party library detection tool 100 may be used to analyze a software bill of materials (SBOM). A SBOM declares the inventory of components used to build a piece of software so third-party library detection/analysis is important for performing an independent analysis of a SBOM.

FIG. 2 is a diagram showing an example of an annotated tree data structure, according to some embodiments. The annotated tree data structure is an example of the signal tree 160 shown in FIG. 1.

As shown in the diagram, the tree data structure includes a root node 205, a “com” node 210, a “domain1” node 215, a “platform” node 225, a “mobile” node 230, a “domain2” node 220, an “ads” node 235, and a “login” node 240.

The “platform” node 225 represents the path “com.domain1.platform” and is annotated with the URL signal. The “mobile” node 230 represents the path “com.domain1.mobile” and is annotated with the class name signal and the class loaded during runtime signal. The “domain1” node 215 represents the sub-path “com.domain1” and is annotated with the class name signal, the URL signal, and the class loaded during runtime signal.

The “ads” node 235 represents the path “com.domain2.ads” and is annotated with the class name XREF signal and the network communication signal. The “login” node 240 represents the path “com.domain2.login” and is annotated with the manifest file signal and the class name XREF signal. The “domain2” node 220 represents the sub-path “com.domain2” and is annotated with the manifest file signal, the class name XREF signal, and the network communication signal.

The “com” node 210 represents the sub-path “com” and is annotated with the manifest file signal, the class name XREF signal, the URL signal, the class loaded during runtime signal, and the network communication signal.

In this example, the manifest file signal is assigned a weight of 5, the class name XREF signal is assigned a weight of 3, the URL signal is assigned a weight of 1, the class loaded during runtime signal is assigned a weight of 3, and the network communication signal is assigned a weight of 5.

The confidence score of a node may be determined by summing the weights of the signals associated with the path/sub-path represented by the node. Thus, as shown in the diagram, the “platform” node 225 (representing “com.domain1.platform”) has a confidence score of 1, the “mobile” node 230 (representing “com.domain1.mobile”) has a confidence score of 4, the “ads” node 235 (representing “com.domain2.ads”) has a confidence score of 8, and the “login” node 240 (representing “com.domain2.login”) has a confidence score of 8. In this example, it is assumed that the “mobile” node 230, the “ads” node 235, and the “login” node 240 have confidence scores that meet the threshold confidence score (these nodes have bolded outlines in the diagram), and thus the paths/sub-paths represented by these nodes are considered as being associated with third-party libraries. Also, due to the hierarchical nature of the tree data structure, the parent nodes of these nodes also have confidence scores that meet the threshold confidence score, and thus the paths/sub-paths represented by the parent nodes are also considered as being associated with third-party libraries.

In an embodiment, the third-party library detection tool 100 reports the paths/sub-paths represented by the nodes having confidence scores that meet the threshold confidence score as being associated with third-party libraries. In an embodiment, the third-party library detection tool 100 just reports the paths/sub-paths represented by the lowest/deepest node in a branch that has a confidence score that meets the threshold confidence score (paths/sub-paths represented by nodes having a confidence score that meets the threshold confidence score but that do not have any child nodes having a confidence score that meets the threshold confidence score). In this example, this would be “com.domain1.mobile”, “com.domain2.ads”, and “com.domain2.login”. In an embodiment, the third-party library detection tool 100 (or a user) may map the paths/sub-paths to corresponding libraries.

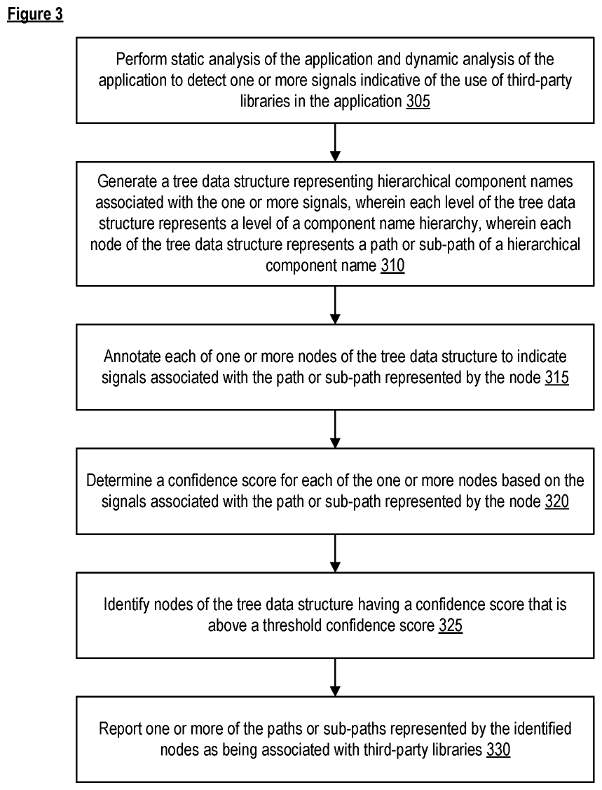

FIG. 3 is a flow diagram showing a method for detecting third-party libraries in an application, according to some embodiments. In an embodiment, the method is performed by one or more computing devices (e.g., that implement the third-party library detection tool 100). The process may be implemented using any combination of hardware, software, and firmware.

The operations in the flow diagram are described with reference to the exemplary embodiments of the other diagrams. However, it should be understood that the operations of the flow diagram can be performed by embodiments of the invention other than those discussed with reference to these other diagrams, and the embodiments of the invention discussed with reference to these other diagrams can perform operations different than those discussed with reference to the flow diagram. Also, while the flow diagram shows a particular order of operations performed by certain embodiments, it should be understood that such order is provided by way of example (e.g., alternative embodiments may perform the operations in a different order, combine certain operations, overlap certain operations, etc.).

At operation 305, the one or more computing devices perform static analysis of the application and dynamic analysis of the application to detect one or more signals indicative of the use of third-party libraries in the application. In an embodiment, the static analysis detects static analysis signals (e.g., code artifacts) associated with the application, wherein the static analysis signals include one or more of: a third-party class name signal, a class name XREF signal, a URL signal, a manifest file signal, and a configuration file signal. In an embodiment, the dynamic analysis detects dynamic analysis signals associated with the runtime behavior of the application, wherein the dynamic analysis signals include one or more of: a network communication signal and a class loaded (and/or method invocation) during runtime signal.

At operation 310, the one or more computing devices generate a tree data structure representing hierarchical component names associated with the one or more signals, wherein each level of the tree data structure represents a level of a component name hierarchy, wherein each node of the tree data structure represents a path or sub-path of a hierarchical component name In an embodiment, the hierarchical component names are class names (e.g., Java class names). In an embodiment, the one or more computing devices determining a level of similarity between a string associated with a signal and a hierarchical component name and associate the signal with the hierarchical component name in response to a determination that the level of similarity between the string associated with the signal and the hierarchical component name meets a threshold similarity level.

At operation 315, the one or more computing devices annotate each of one or more nodes of the tree data structure to indicate signals associated with the path or sub-path represented by the node.

At operation 320, the one or more computing devices determine a confidence score for each of the one or more nodes based on the signals associated with the path or sub-path represented by the node. In an embodiment, each of the one or more signals is assigned a weight representing a confidence level provided by the signal, wherein a confidence score for a node of the tree data structure is calculated based on summing weights of respective signals associated with the path or sub-path represented by the node. In an embodiment, the class name cross reference signal, the network communication signal, and/or the class loaded during runtime signal are assigned higher weights than the class name signal, the URL signal, and the manifest file signal.

At operation 325, the one or more computing devices identify nodes of the tree data structure having a confidence score that is above a threshold confidence score.

At operation 330, the one or more computing devices report one or more of the paths or sub-paths represented by the identified nodes as being associated with third-party libraries. In an embodiment, the one or more paths or sub-paths that are reported are paths or sub-paths represented by those of the identified nodes that do not have any child nodes having a confidence score that meets the threshold confidence score.

In an embodiment, the one or more computing devices generate a fingerprint of non-obfuscated code that has determined to be included in a third-party library, wherein the fingerprint of the non-obfuscated code is generated based on code features of the non-obfuscated code that are not expected to change with obfuscation. In an embodiment, the code features of the non-obfuscated code that are not expected to change with obfuscation include one or more of: function signatures and string constants appearing in code. The one or more computing devices may store the fingerprint of the non-obfuscated code and the non-obfuscated code itself in a data storage. The one or more computing devices may determine whether obfuscated code included in the application matches the fingerprint of the non-obfuscated code and responsive to determining that the obfuscated code matches the fingerprint of the non-obfuscated code, deobfuscate the obfuscated code using the non-obfuscated code.

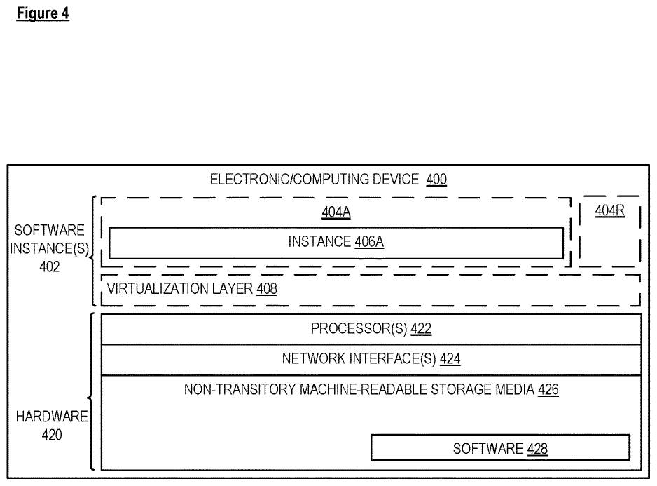

FIG. 4 is a block diagram showing an electronic/computing device, according to some embodiments. FIG. 4 illustrates hardware 420 comprising a set of one or more processor(s) 422, a set of one or more network interfaces 424 (wireless and/or wired), and non-transitory machine-readable storage medium/media 426 having stored therein software 428 (which includes instructions executable by the set of one or more processor(s) 422). Software 428 can include code, which when executed by hardware 420, causes the electronic device 400 to perform operations of one or more embodiments described herein (e.g., operations for automatically detecting third-party libraries in an application).

In electronic devices that use compute virtualization, the set of one or more processor(s) 422 typically execute software to instantiate a virtualization layer 404 and software container(s) 404A-R (e.g., with operating system-level virtualization, the virtualization layer 408 represents the kernel of an operating system (or a shim executing on a base operating system) that allows for the creation of multiple software containers 404A-R (representing separate user space instances and also called virtualization engines, virtual private servers, or jails) that may each be used to execute a set of one or more applications; with full virtualization, the virtualization layer 408 represents a hypervisor (sometimes referred to as a virtual machine monitor (VMM)) or a hypervisor executing on top of a host operating system, and the software containers 404A-R each represent a tightly isolated form of a software container called a virtual machine that is run by the hypervisor and may include a guest operating system; with para-virtualization, an operating system or application running with a virtual machine may be aware of the presence of virtualization for optimization purposes). Again, in electronic devices where compute virtualization is used, during operation an instance of the software 428 (illustrated as instance 406A) is executed within the software container 404A on the virtualization layer 408. In electronic devices where compute virtualization is not used, the instance 406A on top of a host operating system is executed on the “bare metal” electronic device 400. The instantiation of the instance 406A, as well as the virtualization layer 408 and software containers 404A-R if implemented, are collectively referred to as software instance(s) 402.

Alternative implementations of an electronic device may have numerous variations from that described above. For example, customized hardware and/or accelerators might also be used in an electronic device.

The techniques shown in the figures can be implemented using code and data stored and executed on one or more electronic devices (e.g., an end station, a network device). Such electronic devices, which are also referred to as computing devices, store and communicate (internally and/or with other electronic devices over a network) code and data using computer-readable media, such as non-transitory machine-readable storage medium/media (e.g., magnetic disks, optical disks, random access memory (RAM), read-only memory (ROM); flash memory, phase-change memory) and transitory computer-readable communication media (e.g., electrical, optical, acoustical or other form of propagated signals, such as carrier waves, infrared signals, digital signals). In addition, electronic devices include hardware, such as a set of one or more processors coupled to one or more other components, e.g., one or more non-transitory machine-readable storage media to store code and/or data, and a set of one or more wired or wireless network interfaces allowing the electronic device to transmit data to and receive data from other computing devices, typically across one or more networks (e.g., Local Area Networks (LANs), the Internet). The coupling of the set of processors and other components is typically through one or more interconnects within the electronic device, (e.g., busses, bridges). Thus, the non-transitory machine-readable storage media of a given electronic device typically stores code (i.e., instructions) for execution on the set of one or more processors of that electronic device. Of course, various parts of the various embodiments presented herein can be implemented using different combinations of software, firmware, and/or hardware. As used herein, a network device (e.g., a router, switch, bridge) is an electronic device that is a piece of networking equipment, including hardware and software, which communicatively interconnects other equipment on the network (e.g., other network devices, end stations). Some network devices are “multiple services network devices” that provide support for multiple networking functions (e.g., routing, bridging, switching), and/or provide support for multiple application services (e.g., data, voice, and video).

An embodiment may be an article of manufacture in which a non-transitory machine-readable storage medium (such as microelectronic memory) has stored thereon instructions (e.g., computer code) which program one or more data processing components (generically referred to here as a “processor”) to perform the operations described above. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

1. A method performed by one or more computing devices to accurately detect a use of third-party software libraries in an application, the method comprising:
performing static analysis of the application and dynamic analysis of the application to detect one or more signals indicative of the use of third-party libraries in the application;
generating a tree data structure representing hierarchical component names associated with the one or more signals, wherein each level of the tree data structure represents a level of a component name hierarchy, wherein each node of the tree data structure represents a path or sub-path of a hierarchical component name;
annotating each of one or more nodes of the tree data structure to indicate signals associated with the path or sub-path represented by the node;
determining a confidence score for each of the one or more nodes based on the signals associated with the path or sub-path represented by the node;
identifying nodes of the tree data structure having a confidence score that meets a threshold confidence score; and
reporting one or more of the paths or sub-paths represented by the identified nodes as being associated with third-party software libraries.

2. The method of claim 1, wherein the static analysis detects static analysis signals associated with the application, wherein the static analysis signals include one or more of: a third-party class name signal, a class name cross reference signal, a uniform resource locator signal, a manifest file signal, and a configuration file signal.

3. The method of claim 2, wherein the dynamic analysis detects dynamic analysis signals associated with runtime behavior of the application, wherein the dynamic analysis signals include one or more of: a network communication signal and a class loaded during runtime signal.

4. The method of claim 3, wherein each of the one or more signals is assigned a weight representing a confidence level provided by the signal, wherein a confidence score for a node of the tree data structure is calculated based on summing weights of respective signals associated with the path or sub-path represented by the node.

5. The method of claim 4, wherein the class name cross reference signal, the network communication signal, and/or the class loaded during runtime signal are assigned higher weights than the class name signal, the URL signal, and the manifest file signal.

6. The method of claim 1, wherein the one or more paths or sub-paths that are reported are paths or sub-paths represented by those of the identified nodes that do not have any child nodes having a confidence score that meets the threshold confidence score.

7. The method of claim 1, further comprising:
generating a fingerprint of non-obfuscated code that has determined to be included in a third-party software library, wherein the fingerprint of the non-obfuscated code is generated based on code features of the non-obfuscated code that are not expected to change with obfuscation;
storing the fingerprint of the non-obfuscated code and the non-obfuscated code itself in a data storage;
determining whether obfuscated code included in the application matches the fingerprint of the non-obfuscated code; and
responsive to determining that the obfuscated code matches the fingerprint of the non-obfuscated code, deobfuscating the obfuscated code using the non-obfuscated code.

8. The method of claim 7, wherein the code features of the non-obfuscated code that are not expected to change with obfuscation include one or more of: function signatures and string constants appearing in code.

9. The method of claim 1, further comprising:
determining a level of similarity between a string associated with a signal and a hierarchical component name; and
associating the signal with the hierarchical component name in response to a determination that the level of similarity between the string associated with the signal and the hierarchical component name meets a threshold similarity level.

10. A set of one or more non-transitory machine-readable storage media storing instructions which, when executed by one or more processors of one or more computing devices, causes the one or more computing devices to perform operations for accurately detecting a use of third-party software libraries in an application, the operations comprising:
performing static analysis of the application and dynamic analysis of the application to detect one or more signals indicative of the use of third-party libraries in the application;
generating a tree data structure representing hierarchical component names associated with the one or more signals, wherein each level of the tree data structure represents a level of a component name hierarchy, wherein each node of the tree data structure represents a path or sub-path of a hierarchical component name;
annotating each of one or more nodes of the tree data structure to indicate signals associated with the path or sub-path represented by the node;
determining a confidence score for each of the one or more nodes based on the signals associated with the path or sub-path represented by the node;
identifying nodes of the tree data structure having a confidence score that meets a threshold confidence score; and
reporting one or more of the paths or sub-paths represented by the identified nodes as being associated with third-party software libraries.

11. The set of one or more non-transitory machine-readable storage media of claim 10, wherein the static analysis detects static analysis signals associated with the application, wherein the static analysis signals include one or more of: a third-party class name signal, a class name cross reference signal, a uniform resource locator signal, a manifest file signal, and a configuration file signal.

12. The set of one or more non-transitory machine-readable storage media of claim 11, wherein the dynamic analysis detects dynamic analysis signals associated with runtime behavior of the application, wherein the dynamic analysis signals include one or more of: a network communication signal and a class loaded during runtime signal.

13. The set of one or more non-transitory machine-readable storage media of claim 12, wherein each of the one or more signals is assigned a weight representing a confidence level provided by the signal, wherein a confidence score for a node of the tree data structure is calculated based on summing weights of respective signals associated with the path or sub-path represented by the node.

14. The set of one or more non-transitory machine-readable storage media of claim 13, wherein the class name cross reference signal, the network communication signal, and/or the class loaded during runtime signal are assigned higher weights than the class name signal, the URL signal, and the manifest file signal.

15. The set of one or more non-transitory machine-readable storage media of claim 11, wherein the one or more paths or sub-paths that are reported are paths or sub-paths represented by those of the identified nodes that do not have any child nodes having a confidence score that meets the threshold confidence score.

16. The set of one or more non-transitory machine-readable storage media of claim 11, wherein the operations further comprise:
generating a fingerprint of non-obfuscated code that has determined to be included in a third-party software library, wherein the fingerprint of the non-obfuscated code is generated based on code features of the non-obfuscated code that are not expected to change with obfuscation;
storing the fingerprint of the non-obfuscated code and the non-obfuscated code itself in a data storage;
determining whether obfuscated code included in the application matches the fingerprint of the non-obfuscated code; and
responsive to determining that the obfuscated code matches the fingerprint of the non-obfuscated code, deobfuscating the obfuscated code using the non-obfuscated code.

17. The set of one or more non-transitory machine-readable storage media of claim 16, wherein the code features of the non-obfuscated code that are not expected to change with obfuscation include one or more of: function signatures and string constants appearing in code.

18. The set of one or more non-transitory machine-readable storage media of claim 11, wherein the operations further comprise:
determining a level of similarity between a string associated with a signal and a class hierarchical component name; and
associating the signal with the class hierarchical component name in response to a determination that the level of similarity between the string associated with the signal and the class hierarchical component name meets a threshold similarity level.

19. A computing device, comprising:
one or more processors; and
a set of one or more non-transitory machine-readable storage media storing instructions which, when executed by the one or more processors, causes the computing device to:
perform static analysis of an application and dynamic analysis of the application to detect one or more signals indicative of a use of third-party libraries in the application;
generate a tree data structure representing hierarchical component names associated with the one or more signals, wherein each level of the tree data structure represents a level of a component name hierarchy, wherein each node of the tree data structure represents a path or sub-path of a hierarchical component name;
annotate each of one or more nodes of the tree data structure to indicate signals associated with the path or sub-path represented by the node;
determine a confidence score for each of the one or more nodes based on the signals associated with the path or sub-path represented by the node;
identify nodes of the tree data structure having a confidence score that meets a threshold confidence score; and
report one or more of the paths or sub-paths represented by the identified nodes as being associated with third-party software libraries.

20. The computing device of claim 19, wherein the static analysis detects static analysis signals associated with the application and the dynamic analysis detects dynamic analysis signals associated with runtime behavior of the application,
wherein the static analysis signals include one or more of: a third-party class name signal, a class name cross reference signal, a uniform resource locator (URL) signal, a manifest file signal, and a configuration file signal, and
wherein the dynamic analysis signals include one or more of: a network communication signal and a class loaded during runtime signal.
